(19) United States
(12) Patent Application Publication
(10) Pub. No.: US 2019/0211680 A1
(43) Pub. Date: Jul. 11, 2019

(54) NEW TYPE GEAR SYSTEM

(71) Applicant: Athanasios KOTOUPAS, Ano Liosia (GR)

(72) Inventor: Athanasios KOTOUPAS, Ano Liosia (GR)

(21) Appl. No.: 16/328,822

(22) PCT Filed: Aug. 28, 2017
(86) PCT No.: PCT/GR2017/000051

§ 371 Date: Feb. 27, 2019

(30) Foreign Application Priority Data
Aug. 31, 2016 (GR) 20160100448

(51) Int. Cl. F01C 21/00; F04C 18/56; F04C 2/16; F16H 35/02; F16H 39/01

(52) U.S. Cl. CPC F01C 21/007; F04C 18/56; F16H 2035/003; F16H 35/02; F16H 39/01; F04C 2/16

(57) ABSTRACT

The invention is referred to a new type gearing system where the gears are involved between them with an angled formation inclined dentures (1). The gears are found inside a housing (4) while from a hole (2) in their center a transmission axis (3) passes through them. Each housing (4) contains one or more inserting holes (5) and exerting holes (6), in result the air that enters the inserting hole to rotate each gear for the arc of the circle, until it exits from the corresponding exertion hole (6). The application of the new type gearing system can also be done in motors and in liquid and gas pumps, as it requires minimum maintenance and can be made in different sizes depending on each application.

### THE FIELD OF TECHNIQUE

The invention is referred to the field of technique of the mechanical constructions and more specifically in new type gearing systems for each type of engine or motor.

### THE HISTORY ON THE INVENTION

This new gearing system invention, has never been discovered in previous technologies.

The modern engine with the continuous development have offered many engines and motors with different characteristics and technical innovations. Of course some of the had also different requirements in order to function properly. The most famous internal combustion engines, according to their time of operation, are the two-stroke engine, the four-stroke engine and the continuous operation engine. A unique category are the Wankel engines.

During their operation the conventional systems, like the ones mentioned above, according to their type they can have one ignition per circle, two or three, as it happens on Wankel engines. The functionality of these engines as it is more efficient, it appears as it has certain disadvantages, that prevent their full acceptance and their global utilization. Their asymmetric design leads to high oil consumptions during their operation and also has a limited lifetime.

On the other hand four-stroke engines have valves which also frequently appear to have problems during their function. Also the existence of springs for opening and closing the valves, adds a disadvantage as much at the energy consumption as at on the fragility on the specific points.

Finally, two-stroke engines, even though they are simpler on their construction, because of their set up, they display issues which are high emission, fuel and oil oriented.

This invention's object is to front all the mentioned issues and deficiencies of the previous technology, introducing a new gearing system which can be used in any type of engine or motor.

Furthermore this invention targets into offering a new type gearing system, which can be made with two or more gears paired in a row or in different order reassuring unobstructed and continuous operation.

The gearing system is made out of gears in which each gear has dentures with a slight twist, for complete and absolute fit. The gears are completely circular with two deeper cuts in the two sides of the circle and dentures all over the gear's surface.

One more characteristic of this invention is that it has no vibrations during its time of operation.

This system can also be used in internal combustion engines and it can achieve six ignitions per circle during the engine's operation.

Finally this invention has the advantage that it can be used in internal combustion engines without the need of valves, as it happens in four-stroke motors, neither is it asymmetric and with limited lifetime as it happens in rotary engines.

All these characteristics and advantages of this invention will become obvious in the detailed description below.

### SHORT CONCEPT DESCRIPTION

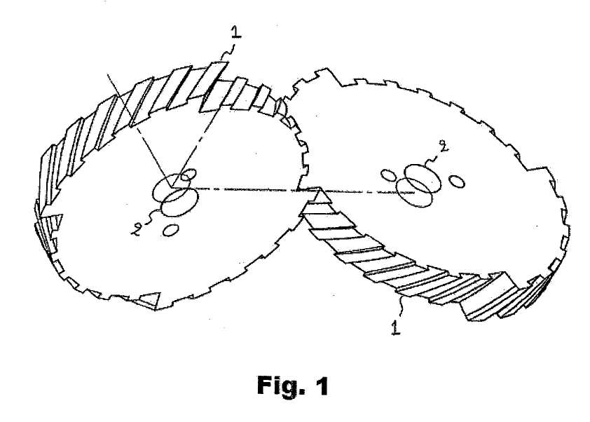

FIG. 1 shows the perspective view of two gears during their involution.

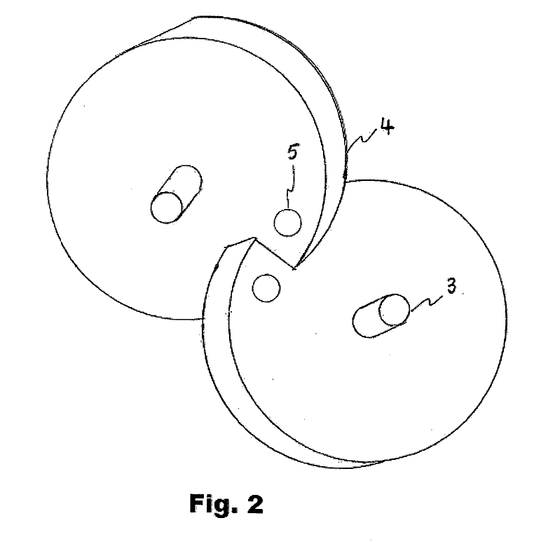

FIG. 2 displays the corresponding dentures of the gears from FIG. 1 with the drive axes.

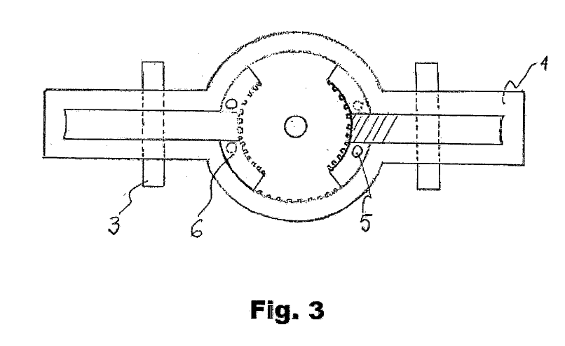

FIG. 3 presents the system of three gears where the central gear is at a 90 degree inclination apart from the other two.

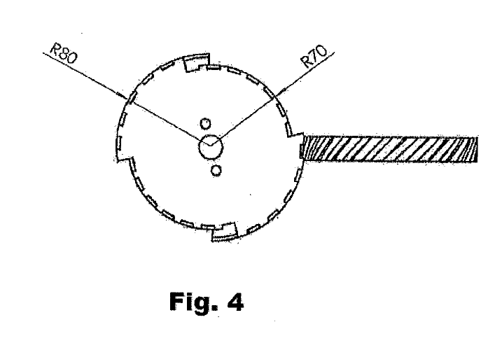

FIG. 4 shows the perspective of two gears, in which the rotation of them is obvious, so the continuous involution between them can be achieved.

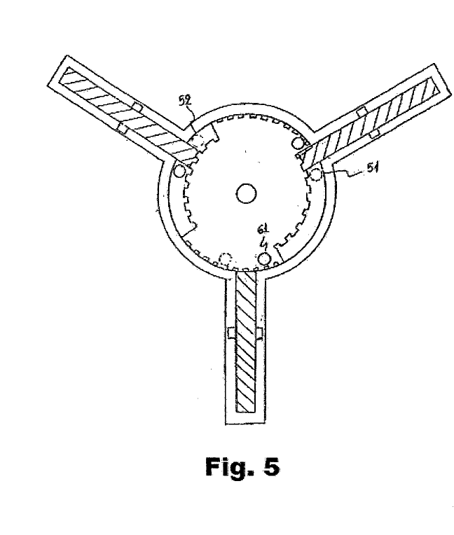

FIG. 5 indicates the four-gear system with the three of them placed at a 120 degree inclination in relation with the central gear.

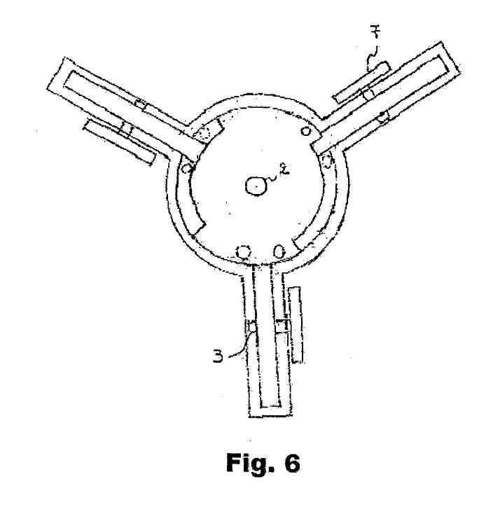

FIG. 6 presents an indicative depiction of four gears which don't have dentures, but they are being meshed with each other because of appropriate provision.

### DETAILED DESCRIPTION OF SUGGESTED APPLICATION

Referring to the additional drawings we will describe indicative applications of a new gearing system of the invention. Each gear has dentures (1) with incline in order to achieve a twist with the pairing gear with which it involves, so their relative position has a 90 degree difference from their rotating axis. If the gears that will be used have the same cross section, then this slope has to be 45 degrees, while in the same way, they will be adapted in case of different cross sections. The goal is to always achieve an unobstructed involvement during their rotation. In the center of each gear there is a hole (2), in which the transmission axis is been inserted (3), FIG. 2. The transmission axis can be made by metal, plastic or any other suitable material depending on the requirements, while its further connection with the elements of each device, is being done in order to transmit the movement that it receives from the gears' rotation. Each gear is been placed inside a housing (4) that functions as protection for the dentures (1), in order to push the compression of the inserted or exerted liquid or gas. The construction of the housing (4) can be made from plastic, metal or any other material depending on where the gearing system will be placed, on the stresses that it is going to take or other constructional requirements that might exist.

Each housing (4) has in on side the inserting holes (5) and on the other side as well the exerting holes (6), FIG. 3, in order the insertion of air to be done with appropriate means, like for example tubes, in order the gears to be rotated and the air to be exerted from the opposite side respectively. If the gear system is composed by two gears, each housing has an insertion hole (5) and an exertion hole (6). In the same way if the gearing system is composed by three gears, like in FIG. 3, each housing (4) has two inserting holes (5) and two exerting holes (6). Continuing if the system is composed be four gears, FIG. 5, each housing (4) has three inserting holes (5) and three exerting holes.

The cross section of the gears is not equable, as seen clearly in FIG. 4, as the arc of the gear has a bigger radius and the arc has a smaller radius. In the particular situation the arc is indicatively in 90 degrees, while its respective configuration exists in the involving gear too.

With that way in the random moment that is appears in FIG. 5, the insertion of the air from the insertion hole (51) causes the rotation of the central gear until it rotates so it closes the insertion hole (51) and the air to come out from the exertion hole (61) while the rotation will be achieved by the air that enters from the insertion hole (52) for the corresponding arc of the circle. So the rotation happens for the central gear and consequently for the other peripheral involving gears from the air that enters from the insertion holes and exits from the exertion holes, for the corresponding arc. As it results from the design and as its obvious, the inserting and exerting holes of the central gear are used in the entire rotating circle of the central gear for the insertion and the exertion of air. On the other hand, in the peripheral gears, only the insertion and exertion air holes that are found on the side of the involution of the dentures (1) with the central gear, are being useful, as the rest of the holes are in the air and don't contribute in the rotation.

In another indicative application of the invention the rotating gears don't have dentures, FIG. 6, but are involved externally with the use of a gear, step motors (7) or other appropriate setup, delivering the movement to the axis (3) and then to the rotating gears. A construction like this could be used for example in liquid or gas pumps, or in internal combustion engines.

At this point it is remarkable to note that the description of the invention was made in reference to indicative application examples, in which of course it can't be limited. So in any other change or modification, concerning the shape, the indicative dimensions, the morphology, the used materials and the components of construction and fitting, because they are not an inventing step and do not help in the technical evolution of the already known, are thought to be included in the goals and the visions of the presence invention.

1. New type gearing system, composed by gears with dentures (1) that are inclined, that are in continuous angled involvement between them, with a transmission axis (3) that passes from the hole (2) in the center of each gear, inside the housing (4), with inserting hole (5) and exerting hole (6), characterized by the fact that air inserts from the inserting hole (5) rotating the gears and exerts from the exerting hole (6).
